(19) United States
(12) Patent Application Publication
(10) Pub. No.: US 2016/0350791 A1
(43) Pub. Date: Dec. 1, 2016

(54) DYNAMIC MULTI-LEVEL REWARDS SYSTEMS AND METHODS USING MULTIPLE DATA SOURCE INPUTS OF ACTIVITY INFORMATION

(71) Applicant: GROOVEO INC., Sherman Oaks, CA (US)

(72) Inventors: ARI SCHINDLER, SHERMAN OAKS, CA (US); CAMILL SAYADEH, SHERMAN OAKS, CA (US); ADI MCABIAN, SHERMAN OAKS, CA (US); BJORN NICLAS TUFVESSON, SHERMAN OAKS, CA (US); REID MORAN, SHERMAN OAKS, CA (US); GREGORY A. PICCIONELLI, SHERMAN OAKS, CA (US)

(21) Appl. No.: 15/160,967

(22) Filed: May 20, 2016

Related U.S. Application Data
(60) Provisional application No. 62/166,790, filed on May 27, 2015.
(60) Provisional application No. 62/253,238, filed on Nov. 10, 2015.

(51) Int. Cl. G06Q 30/02; G06Q 50/00

(52) U.S. Cl. CPC G06Q 30/0231; G06Q 50/01; G06Q 30/0276

(57) ABSTRACT

A dynamic multilevel rewards systems using multiple data source inputs of activity information.

### CROSS REFERENCE TO RELATED APPLICATIONS

This application claims the benefit of U.S. Provisional Application Ser. No. 62/253,238 entitled “DYNAMIC MULTI-LEVEL REWARDS SYSTEMS AND METHODS USING MULTIPLE DATA SOURCE INPUTS OF ACTIVITY INFORMATION,” filed on Nov. 10, 2015 and U.S. Provisional Application Ser. No. 62/166,790 entitled “CAREER AND REWARD MANAGEMENT SYSTEM,” filed on May 22, 2015, the contents of which are hereby incorporated by reference herein in their entirety.

### TECHNICAL FIELD

The present invention relates generally to a reward system implemented on a computer and more particularly to a multi-level reward system with multiple inputs of activity information.

### BACKGROUND

Nearly ubiquitous broadband Internet access and the ease with which persons and companies can now provide vast amounts of content, personal and other information in and through social media like FACEBOOK®, TWITTER®, LINKEDIN®, INSTAGRAM®, YOUTUBE®, Tumblr, STAGE 32® and other online media online sites, currently provides extraordinary opportunities to acquire information about persons and their behaviors that can be of great value to many marketers and providers of products and services, seekers of monetary donations or capital investment, persons or businesses desiring to establish or increase brand awareness and others. Such information can be used to determine, and in some cases, predict, consumer preferences and behaviors. Another types of approaches that can affect consumer preferences are rewards systems that are responsive to, and used in coordination with, user information to influence consumer behavior. But while vast amounts of information are being generated, stored, and disseminated via the Internet and other digital networks, there is a vast unmet need to effectively gather, recognize, characterize, analyze and use such data in the service of specific tasks, such as, for example, the marketing and sale of recorded music, the marketing and promotion of a music artist and/or his or her “brand,” the promotion and sale of tickets for concerts and shows, and the marketing and sale of products and services created, produced or otherwise provided by a music artist. This is particularly the case regarding information regarding behaviors that might not immediately appear to have relevance in association with the marketing or sale of products or services or the effective solicitation of monetary donations or capital investment.

In view of the foregoing, there is an ongoing need for systems, apparatuses and methods for efficiently processing data from various sources to predict and promote actions for marketers and providers of products and services.

### SUMMARY

In view of the above, an approach for systems, apparatuses and methods for efficiently processing data from various sources to predict and promote actions for marketers and providers of products and services is described. The systems, methods, and tangible, computer-readable storage medium of the present invention provide a way of acquiring, analyzing, and using multiple sources of digitally characterizable information that directly or indirectly relate to one or more person's behaviors to effect, improve or enhance the marketing and/or sale of specified products or services, to increase brand awareness, to incentivize and/or facilitate monetary donations, to acquire investment capital, and/or to assist in the management of personal or business careers.

Principal embodiments of the invention utilize novel dynamic multilevel rewards-providing systems that obtain data from a plurality of selectable sources of digitally characterizable behavior information that is subjected to novel forms of causation analysis to achieve the foregoing. Specific embodiments of the invention, which include one or more Career Manager engines, provide means of enhancing the careers of music performers and composers, to build public awareness of such performers and composers and their music, to increase revenues to such performers and composers via enhanced live show ticket and/or recorded music sales, to increase the number of remunerating performances of such performers' or composers' music, and/or to acquire monetary donations for, and/or investments in, the performer's company(ies), music, projects, career, etc. The systems methods, and tangible, computer-readable storage medium means of the present invention are sometimes hereinafter referred to, for convenience, in a non-limiting manner, as “Multisource Acquired and Data Causation Analyzed Reward Systems” or “MADCARS”.

In some embodiments of the invention MADCARS uses a multilevel rewards system, method, or computer-readable storage medium, effectuated via the Rewards Manager, that rewards Activities by persons through “a bottom up” rewarding regime in which rewards are preferentially distributed to distal causal actors verses proximate causal actors (as is the case in traditional “top down” multilevel marketing rewards regimes). Also unlike traditional referral-based rewards systems or multilevel marketing regimes that provide rewards to members or persons within a defined organization or group description, in the instant invention, rewards are provided to persons regardless of affiliation with or membership in any organization or group description. In some preferred embodiments of the invention, for example, rewards are provided to persons who have no affiliation with a provider or user of MADCARS and such persons may not be aware that rewards have been paid, reserved, or otherwise awarded to them and/or continue to accumulate on their behalf.

In this regard, in some preferred embodiments of the invention, utilizes a novel rewards system that uses the wealth of information that is now available through social media and other digital data sources to determine and locate activities undertaken by persons that can be inferentially causally linked to a desired outcome by a person or business, such as for example a music artist that seeks to increase activities that lead to greater ticket sales to his or her live shows. For example, the use of a person's geo-location data, biometric data, payment and purchase data, social association data, etc., MADCARS the instant invention, through the use of data gathering from a plurality of sources, such as by scraping data from a plurality of social media, and application of inferential causal analysis to determine and administer rewards via a bottom up multilevel rewards regime, exploits the availability of vast and growing amounts of accessible personal, behavioral, and other data in a novel and nonobvious manner to create a rewards regime that provides to a rewards provider a more effective use of Rewards Resources in relation to the attainment of the goal or object of the use of such Rewards Resources.

Preferred embodiments of the invention also provide novel and nonobvious means more efficiently and effectively track the effectiveness of the providing of rewards administered through the aforementioned rewards system, method, or computer-readable storage medium. For example, some embodiments are useful for collaborating on a song, software, a design for a building, or any other creative, logical, or any other type of collaborative situation. In various embodiments, the participation in the collaboration is tracked so that those who submitted ideas can be rewarded with rights, such as a right to be compensated for their idea(s). This can encourage a stranger to collaborate with other stranger(s) because they can trust that their ideas will be rewarded.

Various embodiments of methods of the present invention are envisioned to be carried out on a digital device, such as a computer system, which include one or more integrated circuits that may include one or more processors/controllers, one or more network interfaces (i.e. Ethernet, Wi-Fi, BLUETOOTH™, 3G, 4G, serial communication, etc.), graphic processors, audio processors, displays, user input devices, one or more power supply, cooling systems, and one or more signal buses. Various embodiments of such systems include programmable or special-purpose devices. Some embodiments of the system include one or more memory devices (internal and/or external-including network storage). Various embodiments include persistent memory, non-persistent, or a combination or persistent and non-persistent memory. Some embodiments include dynamic or static random access memories, flash memories, electronically erasable programmable memories, or the like. Some embodiments include memory that has instructions embedded therein, such that if executed by a programmable device, the instructions will carry out methods as described herein to form systems and devices having functions as described herein. Digital devices may be configured to provide database services, other services, engines (i.e. career manager engines), routing or other portions of The System individual or together on a digital device via execution of machine readable instructions, such as a programming language. It is understood that a computer system may encompass any processor controlled digital device including server, laptop, desktop, embedded controller, smart device, etc.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood by referring to the following figures. The components in the figures are not necessarily to scale, emphasis instead being placed upon illustrating the principles of the invention. In the figures, like reference numerals designate corresponding parts throughout the different views.

FIG. 1 is a network diagram of network elements including a MADCARS residing on a server in the network in accordance with an example implementation of the invention.

FIG. 2 is a block diagram that depicts the server with the MADCARS shown in FIG. 1 in accordance with the example implementation of the invention.

FIG. 3 is a block diagram that depicts the client that access the MADCARS of FIG. 1 in accordance with an example implementation of the invention.

FIG. 4 is an illustration of the dataflow of the MADCARS of FIGS. 1 and 2 in accordance with an example implementation of the invention.

FIG. 5 is an illustration of a user interface for the MADCARS of FIG. 1-3 in accordance with an example implementation.

FIG. 6 is an illustration of a flow diagram of an approach for MADCARS executed by the server in accordance with an example implementation of the invention.

### DETAILED DESCRIPTION

Definitions and Descriptions of Some Specific Components of the System.

“Activity” means any action that can be digitally described or otherwise characterized. In some embodiments of the invention an Activity is a digitally characterizable action or data that is made recognizable by The System (such as by the Activity Scraper, Causality Analyzer and/or Campaign Manager) as an action that will generate a Reward. Without limiting the foregoing, the term “Activity” includes digitally describable or characterizable behaviors or other actions by one or more persons.

“Activity Scraper” means a part of the MADCARS that acquires information, such personal information and Activity information, from a plurality of sources, such as from social media sources.

“Beatcoin™” means a virtual currency that is used as an value exchange medium for Rewards and/or purchases of products or services through or in direct or indirect association with some embodiments of the MADCARS that are directed to applications in the field of music.

“Campaign” means a promotional campaign, an advertising campaign, a sales campaign, political campaign, a personal or professional goal attainment campaign, a company goal attainment campaign, or any other endeavor directed to the achievement of project or goal, including, without limitation, any type of digitally characterizable objective that is effectuated by or through the use of the MADCARS.

“Campaign Manager” means a component part of the MADCARS that maintains one or more lists of criteria to be used for providing rewards to persons for Activities. For example, in some embodiments of the invention, for a music artist promotional Campaign the Campaign Manager is programmed to maintain a list of Activity criteria that result in ticket sales for one of the music artist's live shows. Maintains list of rewards associated with each such Campaign.

“Causality Analyzer” means a component part of The System that Analyzes the Activity information placed in the activity database by the Activity Scraper (input) and infers causality between such Activities (action) and places causal links in the Causality Database (output).

“Computer Device” means a general-purpose computer, a special-purpose computer, a mainframe, a gaming device, a tablet computer, a smartphone, a PDA, an audio player, an audio editor, a text reader, a text editor, a video player, a video editor, a image/graphic reader, an image/graphic editor, a virtual reality device, a processor-based device, and the like. Without limiting the foregoing, the term “Computer Device” shall include, without limitation, any other digital device that is capable of directly or indirectly accessing the Internet and processing programs or other code. It is to be understood that the term “Computer Device” is to be construed broadly to mean any kind of digital device capable performing the computational functions that are associated with the functions and/or use of the MADCARS. The term “Computer Devices” shall include, without limitation, devices that function through the use of silicon-based processors, as well as devices that function through the use of organic processors, quantum computing processors, combinations of the foregoing, and all improvements thereof now known or hereinafter invented.

“Ghost Points” means points that only have value within the MADCARS or a subset thereof. In preferred embodiments of the invention Ghost Points are provided to persons by The System as Rewards. In some other embodiments of the invention Ghost Points have value for a preset or dynamically determined period of time. In some other embodiments of the invention Ghost Points are convertible to one or more other types of points and/or monetary units and/or other things of value.

“MADCARS” and “Multisource Acquired Data And Causality Analyzed Rewards Systems” interchangeably mean the systems, methods, processes and tangible, computer-readable storage medium comprising the invention set forth in this application, and such terms also mean, without limitation, specific embodiments of the invention.

“Rewards” means the providing of one or more benefits by the MADCARS to a person, entity or device. The term “Rewards” includes, without limitation can be value points, actual money, imaginary money, virtual currency value units, such as units of Bitcoins®, Beatcoins™, Rays™ or other virtual currency value units, or other units of, or other things of, value convertible to dollars, another actual or virtual currency or some other thing or things of value. “Rewards” may be currency, merchandise, ranking, private or public messages or praise by friends or celebrities, personalized gifts, or rewards invented by the system based on the observed, reported, or inferred likes and interests of the person or group.

“Rewards Manager” means one or more systems, methods, processes and tangible, computer-readable storage media that reward activities of a person or group, by monitoring and analyzing their public and private activities, comparing this information to various objectives set by persons, groups, or the system itself, and distributing rewards for the activities the system (through the action of the Causality Analyzer) deems most effective at achieving the objectives.

“User App” means one or more applications that provide a User App Interface that enables users to engage, through the use of a Computer Device, certain functionalities of The System described in association with the User App Interface below.

“User App Interface” means the interface through which a user engages the functions of the User App portion of The System.

“UAU” means a User App user.

### Preferred Embodiment of an Example Implementation

To facilitate an understanding of embodiments, principles, and features of the present invention, they are explained hereinafter with reference to implementation in illustrative embodiments. In particular, they are described in the context of a reward system implemented as instructions executed by a processor locate on a server connected to a network.

The components and materials described hereinafter as making up the various embodiments are intended to be illustrative and not restrictive. Many suitable components and materials that would perform the same or a similar function as the materials described herein are intended to be embraced within the scope of embodiments of the present invention.

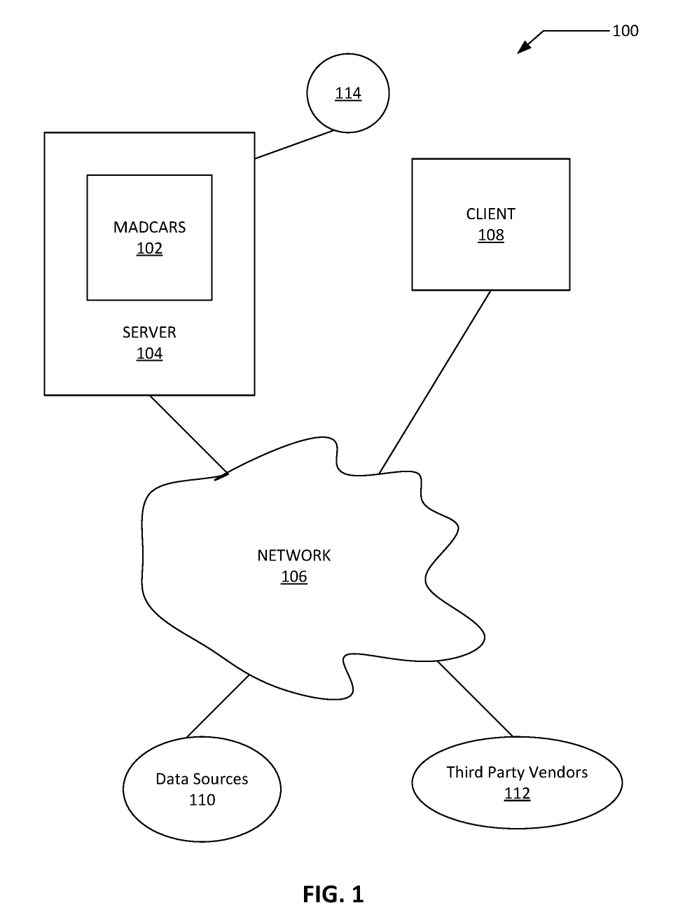

An approach is described for a Multisource Acquired Data And Causality Analyzed Rewards Systems (MADCARS). Turning to FIG. 1, a network diagram 100 of network elements including a MADCARS 102 residing on a server 104 in the network 106 that is connected to a client 108 in accordance with and example implementation of the invention is depicted. The network 106 may connect the server 104, client 108, data source 110 and third party vendors 112 together enabling the MADCARS 102 on server 104 to receive and send data/messages to other devices coupled to the network 106. The MADCARS 102 may also access data stores external to the server 104, such as datastore 114. In other implementations, the data store may be accessed via the network 106. In yet other implementations, the data store 114 may be stored internal to server 104. The data store 114 may also be distributed among multiple data stores accessed via the “cloud”.

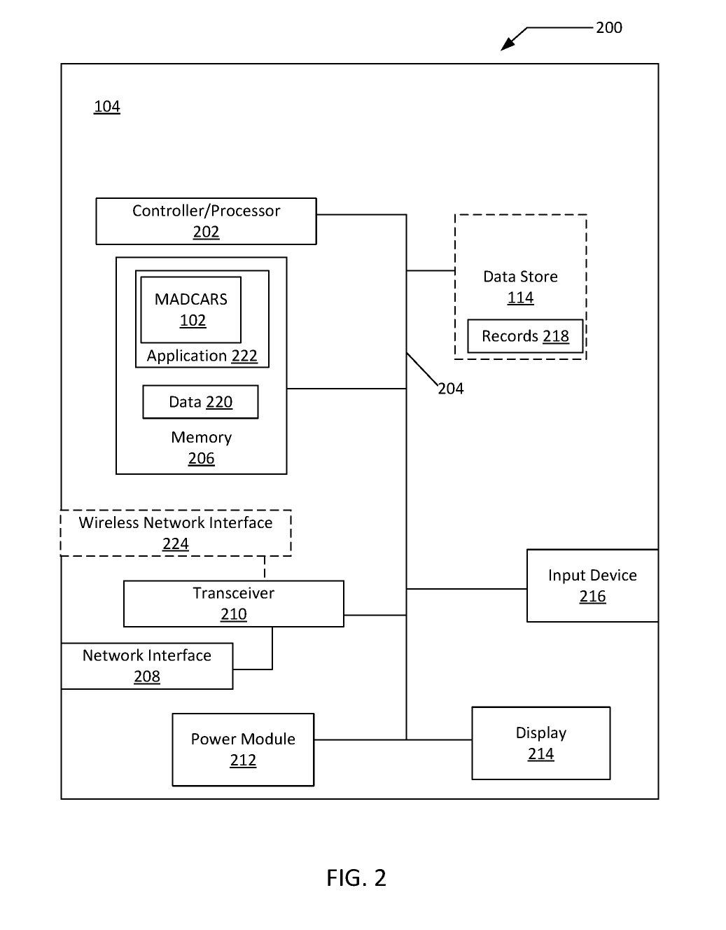

In FIG. 2, a block diagram 200 of the server 104 with the MADCARS 102 of FIG. 1 is depicted in accordance with the example implementation of the invention. The server 104 is a computer device with one or more controllers/processors 202 and each controller/processor may have one or more processing cores. The controller/processor 202 is coupled to a data/address electrical bus 204. The data/address electrical bus 204 is typically coupled to a memory 206, network interface 208 via a transceiver 210, power module 212 (sometime referred to as a power supply), display interface 214, input device 216 (typically via universal serial bus (USB) interface), data store 114. The memory 206 may be a type of RAM that is read/writable (i.e. SDRAM, SODIM, DIMM, ect . . . ). The memory 206 is divided into a data area 220 and application area 222. The application area 222 stores the plurality of instructions that when executed by the controller/processor 202 implements the MADCARS 102 system.

The data store 114 may be implemented as a flat file, relational database, data structure, or similar construct that is able to store and retrieve multiple data records 218. The data store may reside in solid state memory, hard disks, or CD/DVD type memory. If the data store 114 resides outside of server 104, then the data records 218 would be accessed via the transceiver 210 and network interface 208 via the network 106 of FIG. 1. The network interface 208 is typically a wired 802.3 network interface and couple to the server 104 to a local area network and internet. In other implementations, the server 104 may connect to the network 106 of FIG. 1 with wireless network interface 224.

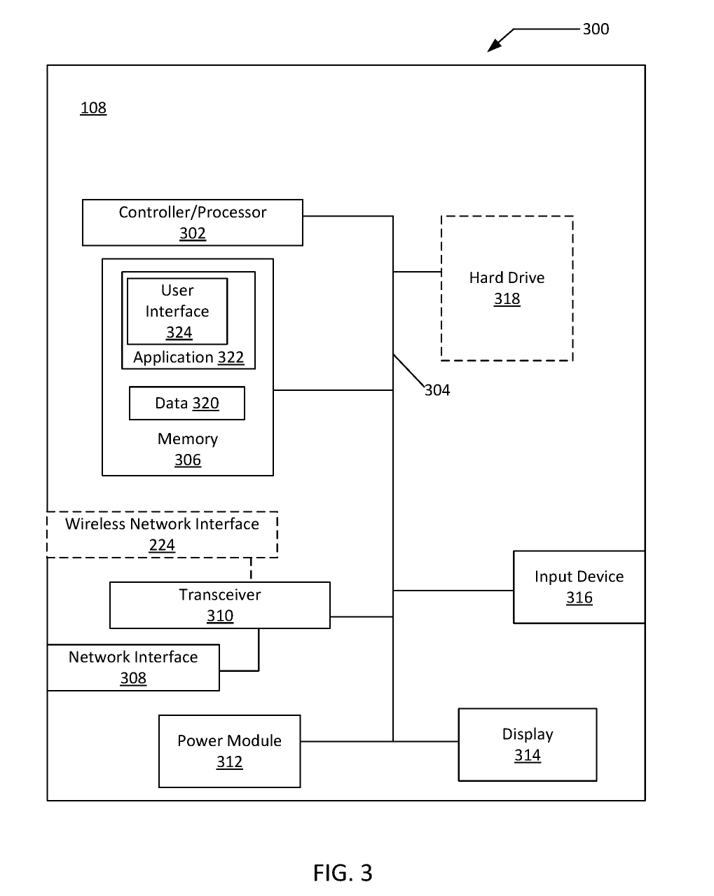

Turning to FIG. 3 is a block diagram 300 of the client 108 of FIG. 1 that access the MADCARS 102 of FIG. 1 in accordance with an example implementation of the invention. The client 108 is a computer device with one or more controllers/processors 302 and each controller/processor may have one or more processing cores. The controller/processor 302 is coupled to a data/address electrical bus 304. The data/address electrical bus 304 is typically coupled to a memory 306, network interface 308 via a transceiver 310, power module 312 (sometime referred to as a power supply), display interface 314, input device 316 (typically via universal serial bus (USB) interface), hard drive 318. The memory 306 may be a type of RAM that is read/writable (i.e. SDRAM, SODIM, DIMM, etc . . . . ). The memory 306 is divided into a data area 220 and application area 322. The application area 322 stores the plurality of instructions that when executed by the controller/processor 202 implements the user interface 324 system. Communication with the server 104 may be accomplished by the MADCARS user interface 324 being implemented as a web application that communicates with a webserver located at the server 104 in the current implementation. The term web application is inclusive of application made with markup language such as HTML, JAVA, or other similar applications that are created or generated to communicate with a webserver.

The data store 114 may be implemented as a flat file, relational database, data structure, or similar construct that is able to store and retrieve multiple data records 218. The data store may reside in solid state memory, hard disks, or CD/DVD type memory. If the data store 114 resides outside of server 104, then the data records 218 would be accessed via the transceiver 210 and network interface 208 via the network 106 of FIG. 1. The network interface 208 is typically a wired 802.3 network interface and couple to the server 104 to a local area network and internet. In other implementations, the server 104 may connect to the network 106 of FIG. 1 with wireless network interface 224.

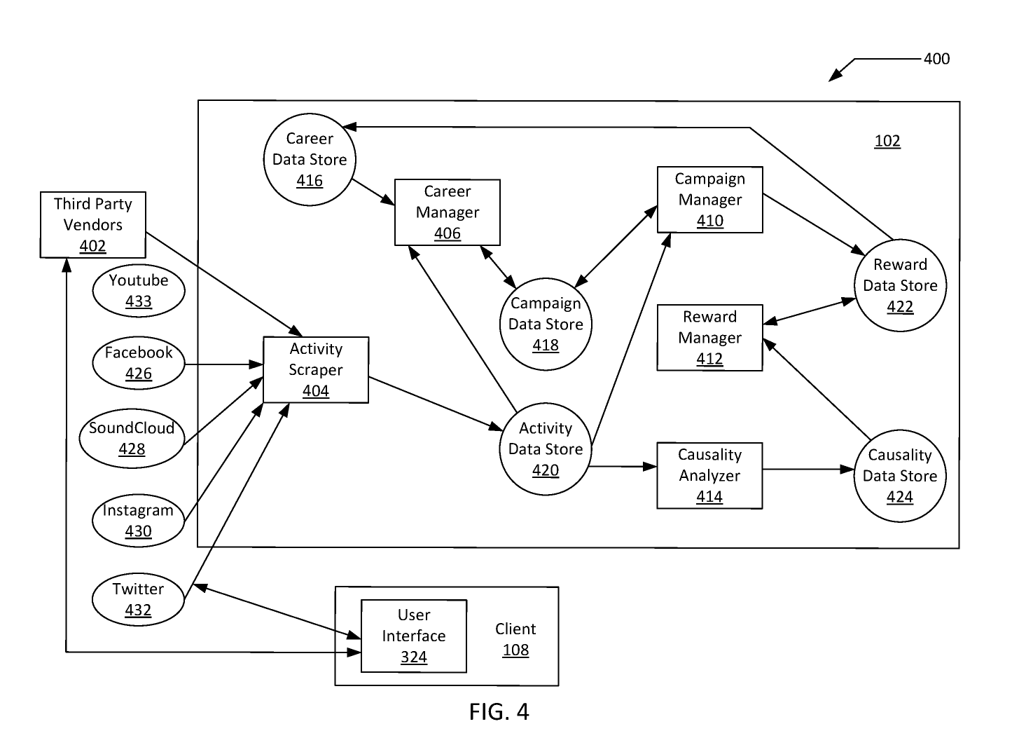

In FIG. 4, an illustration 400 of the dataflow of the MADCARS 102 of FIGS. 1 and 2 in accordance with an example implementation of the invention. The MADCARS 102 is depicted with an activity scraper 404, career manager 406, campaign manager 410, reward manager 412 and causality analyzer 414. The career manager 406 can receive career information from a career data store 416. The career manager 406 and campaign manager 410 receives data from a campaign data store 418 and activity data store 420. The activity scraper 404 and causality analyzer 414 also communicate with the activity data store. The career data store 416 and reward manager 412 can communicate with the reward data store 422. The reward manager 412 and causality analyzer 414 can communicate with the causality data store 424. The activity scraper 404 scrapes/receives data associated with events or people from social media such as FACEBOOK, SOUNDCLOUD, INSTAGRAM, TWITTER, and YOUTUBE 426-433, and third party vendors 402. A MADCARS user interface 324 may be run on a client 108 and access social media 426-432, third party vendors 402, and communication with an activity scraper 404.

The career manager 406 provides virtual management and guidance of the personal and professional career of a person or group, by monitoring and analyzing their public and private activities and achievements, comparing this information to internal models and historical data on other persons and groups, suggesting personal and professional courses of action to advance the career in question, and initiating courses of action itself to advance the career in question. Historic career information is stored in the career data store 416 and accessed by the career manager 406. For example, the MADCARS 102 might identify two musical artists with partially overlapping audiences, suggest to each of them that they should create a collaborative track together, and then reach out to appropriate press contacts to mention that the artists are discussing a possible collaboration because of the correlation of data identified by the career manager 406 recorded for each artist contained in the career data store 416.. Information to feed the analysis conducted by the career manager 406 may come from sources including public blogs, websites, periodicals, broadcasts, as well as social media, friend maps, group affiliations, declared and implied affinities, geolocation data, other sources that the system has access to through permissions granted by users, as well as direct input of information by users or staff. The analysis and internal models may be created, modified, and evolved by expert systems, genetic algorithms, neural networks, probabilistic reasoning, statistical analysis, symbolic logic, or other forms of natural and artificial intelligence. The courses of action suggested by the MADCARS to advance the career may include reaching out to specific users, fans, promoters, bookers, agents, influencers, press, as well as collaborations with other persons or groups, and specific creative projects, such as tracks, albums, movies, and television or web series.

In some implementations, such as when the career manager 406 is engaged in regard to the career of an artist, such as a music artist, the portion of the MADCARS comprising the career manager 406 processes and analyzes audience demographics from multiple different artists, determines that a particular movie director appeals to an audience overlapping the audience of a particular musician, and puts them together for a collaboration. In some embodiments, the MADCARS might also recognize which influencers or members of the press are part of the audience overlapped by both artists, and connects with them to promote the collaboration. In yet other implementations, the career manager analyzes press on websites such as Variety or TMZ, determines that the person whose career is being managed has a public image that is too innocent, and recommends that they make a sex tape, have an affair, or engage in some other scandal, in order to generate edgier press. i.e. the analyzes can convert or otherwise score publicity and then using the score make a determination as to the innocence of the public image.

The career manager can analyzes geolocation data, ticket purchase behavior, and the tracks that people are listening to, using the activity data store 420, campaign data store 418 and career data store 416 and determines that a particular artist would have a successful show at a specific venue using comparison an correlation approaches on the data. The career manager may then recommends that booking to the venue and artist. Alternatively, if the career manager 406 determines it would be more effective to reach out to the fans, it may contact the most influential fans and press relevant to that venue, and help them organize a campaign to bring that artist to that venue.

In some embodiments, such as for example, when the MADCARS 102 is engaged in regard to the management of the career of a politician or in regard to a political campaign, the MADCARS, through or in association with the functioning of the career manager 406, may be used, for example, to analyze geolocation data, user posts and likes to determine likely voter response. For example, the MADCARS via the career manager 406 might directly or inferentially reveal that democratic political candidates in a given region are more likely to be elected if they take a particular stance on gun rights, and as a result the career manager 406 informs the candidate of this finding and, in some embodiments, suggests to the candidate that he or she adopt a stance consistent with the finding.

In yet other implementations, the MADCARS, through, or in association with, the functioning of the career manager 406 analyzes the licensing patterns of music in movies and television, along with the content of those tracks, and determines that tracks of a given length, musical structure, and emotional tone generate more licensing revenue for the artist, so it identifies artists who are close matches to these parameters, and suggests what types of tracks they should work on for licensing revenue. It may go so far as to suggest other tracks or elements to sample, or lyrical elements to include.

In still other implementations of the invention, the MADCARS, through or in association with the operation of the career manager analyzes and identifies the licensing patterns of music as above, and determines that particular tracks are perfect for the work of particular directors or show runners, and recommends those specific tracks to them, based on their personal tastes, the contents of their shows, or the listening, purchasing, and affinity behavior of their audiences.

In some preferred embodiments of the invention, the MADCARS, in association with the operation of the career manager 406 analyzes listening behavior, geolocation data, and audience demographics, and puts together a complete tour for an artist or series of artists, choosing the best cities to visit, the best venues to play in those cities, the best photo ops or places to be seen by the press, and any other activities that would be handled by booking agents, press agents, and managers. The MADCARS via the career manager 406 may optimize the tour for revenue, for positive press and career advancement, or any number of other factors.

In some preferred embodiments of the invention, the MADCARS, through or in association with, the career manager 406, analyzes postings and comments and videos about the person whose career is being managed, and determines that they are perceived as being physically attractive, but not widely considered a sex symbol, so the system arranges for them to be photographed at the beach, or in sexy clothing at a club. In yet other embodiments of the invention, the Career Manager can provides online environment for linking artists, such as audio and video artists, and prenegotiates rights for collaborative product(s).

It is understood that the actions of the career manager 406 may be initiated automatically, in response to a user's prompt, or upon preconditions being met in the career manager 406 in response to activities identified in the activity data store.

The activity scraper 404 acquires information, such personal information and Activity information, from a plurality of sources, such as from social media sources. In preferred embodiments of the invention the activity scraper 404 pulls data from web, social media platforms, email newsletters, scanted reports and periodicals. The activity scraper 404 makes use of access rights and login information provided by users who linked their social media accounts and/or other accounts to the MADCARS (e.g. via the use of the User App or as an option participation in a Campaign, etc . . . . The activity scraper takes bulk feeds from one or more social media and/or other platforms (e.g., takes a dump of data from the platform(s)) and parses raw activity data into structured proprietary representation of likes, shares, posts, reposts, follows, favorites, listens, views, ratings, emails to friends, phone calls to friends, or other digitally describable actions by one or more persons.

A novel feature of current example implementation of the invention is the scraping, and other gathering, of activity information for both users of the MADCARS (e.g., users of the User App, etc.) and non-users, because the MADCARS analyzes and rewards the results of such person's behaviors, even if it influences a non-user of the System. For example, a user Tweets about a show of Artist X. 15 non-users of the MADCARS retweet the tweet. Another 50 users of the MADCARS retweet those tweets. John would be rewarded for all that activity resulting from his tweet. In other embodiments of the invention, an action that could result in one or more rewards to a person would be signing up to be a DJ for an Internet Radio Station that is accessible via the Free Music On Demand Service described in this disclosure.

The campaign manager 410 maintains one or more lists of criteria to be used for providing rewards to persons for activities. For example, in some embodiments of the invention, for a music artist promotional campaign, the campaign manager 410 may be programmed to maintain a list of activity criteria that result in ticket sales for one of the music artist's live shows and also maintains list of rewards associated with each such campaign. The rewardable activity criteria is inputted into the campaign manager through selection from a list options displayed to a user of The System via a user interface. For example, in some embodiments of the invention, a user, such as a music artist engaging the use of The System would be provided through a user interface interfacing with the Campaign Manager a display on the user's Computer Device screen a box in which questions such as the following might be presented:

“Which of the following would like to offer to promote your show
40 Bcatcoins™
$5 dollars
Show tickets
A shout out
An opportunity to go on a date with you, the artist

In the current implementation the MADCARS is advised of actions taken or to be taken by other users in regard to a campaign. In other embodiments, the MADCARS through the functioning of the Campaign Manager 410 provides a means of securing permission from a user that has engaged the use of MADCARS to effectuate a promotional campaign (such as a music artist) by another user of MADCARS desiring to participate in the campaign. For example, the campaign manager 410 is able to output to the display 314 of the client 108 a respondable (via engagable link(s)) authorization request from the other user such as “I would like to promote your show on Oct. 21, 2016, is that OK? Y/N.”

Similarly, in other implementations, a user that has engaged the use of the MADCARS to effectuate a promotional campaign could use the MADCARS through the functioning of the campaign manager 410 to solicit the promotional assistance of one or more other users of the MADCARS, in which case, the campaign manager 410 might, for example, provide a message and respondable link displayed on the display of such other users' Computer Devices a messages such as the following:

“What would you like to promote? (click all that apply)

a. Follow me on Instagram®

b. Buy a ticket to my show on Oct. 21, 2017 in Los Angeles

c. Post about me,

d. Send out 50 tweets about me

e. Send a link to my song “Its All About Me” to 50 persons.

The activity criteria maintained by the campaign manager may include a narrow or a broad range of criteria. It may include a single criterion or a plurality of any number of criteria. The activity criteria maintained by the campaign manager 410 may also be of any type of action, behavior, characteristic, or association that is digitally characterizable. In some implementations, the activity criteria pertains to a type of activity, such as a post, a like, a tweet, a retweet, a blog, a reblog, etc. In other implementations, the rewardable criteria may be specifically tied to one or more types of results such as ticket purchase for one or more specific shows or the promotion of a live performance of an artist accessible via the user interface 324 running on a client or other digital device, through social media posting, tweeting, emailing, blogging, etc. In yet other implementations, the criteria may include properties of the user taking the action. For example, the criteria for rewardable activity may be the purchase of a ticket to a live music event by women aged 21 to 29, or ticket purchases by fans of a specific artist, or by persons that own a specific type of car, have a particular eye color, hair color, race, height, sexual orientation, specific interests, place of employment, schools attended, income range, level of social media activity, venues frequented, past purchases, brands they like, location, specific tracts they listen to, etc.

Rewardable activity criteria established via the campaign manager 410, may also be associated with physical location or time. For example, the rewardable criteria might be or include one or more requirements that a person or a plurality of persons are, or have been, in a specific place at a specific time where such presence at a location is determined by geolocation of a computer device closely physically associated with such person(s). The rewardable criteria can include specific time(s) that one or more activities are rewardable. In some implementations, determination of whether such location and/or time based criteria are satisfied is determined by geolocation of a computer device closely physically associated with the person.

In yet other implementations, such rewardable activity criteria may be programmed by a user of MADCARS to be administered via the campaign manager 410 in a dynamic fashion, in relation to type, time, location, intensity of action, etc. For example, in some embodiments of the invention, rewardable Activity criteria may change over a predetermined time period, or be applied differentially based on the location at which the activity occurs. In some embodiments of the invention the activity criteria may also be dynamic in relation to the type of activity. In still other embodiments of the invention, the activity criteria dynamically changes in accordance with a combination of any of the foregoing or other modes of change. Criteria definitions can dynamic by type, time, location.

The rewardable activity criteria to be used by the campaign manager 410 can be selected by a user of MADCARS (such as music artist seeking to enhance the artist's ticket or music sales, brand awareness, etc.) or from a plurality of criteria displayed on an MADCARS user interface on a digital device. Without limiting the foregoing, it is to be distinctly understood and in preferred embodiments of the invention one or more rewards provided to a person by or through the operation of MADCARS can result from an activity of another person. In other implementations, the activities criteria that will be used to determine and provide rewards to persons is suggested or provided by the career manager 416. In some implementations, the types of rewardable activities maintained by the Campaign Manager 410 are determined algorithmically. In current implementations, the MADCARS allows a user (such as a music artist) to define the activity criteria maintained by the Campaign Manager 410. Such criteria may be practically any behavior or other Activity that is digitally describable.

Without limiting the foregoing, it is to be understood that the criteria could be virtually any digitally characterizable criteria. In some preferred embodiments of the invention, the campaign manager 410 outputs data detailing results of campaign to the user of the MADCARS (such as to a music artist user) via the user interface 324. In some preferred embodiments data regarding the results of the campaign is outputted to career manager 406.

The causality analyzer 414 analyzes the activity information placed in the activity database by the activity scraper 404 (input) and infers causality between such activities (action) and places causal links in the causality data store 424 (output). In some implementations, the inference of causality is provided through the operation of one or more algorithms directed to providing such inferences. For example, the causality analyzer 414 is directed to revealing causal inferences between activities, between activities and the happening of one or more events, the accomplishment of goal or milestone set forth in the campaign manager 410 and/or career manager 406, the realization of a campaign goal or objective or the existence or non-existence of an event, a state, a circumstance, a preference, a trend or any other digitally characterizable reality.

In the current example implementation, the causality analyzer 414 performs its function in a “heterogeneous” manner, that is, unlike similar correlation analysis known to be performed by many operators of major social media platforms regarding their own members, unlike such “homogeneous” analysis, whereby the analysis pertains only to activities of persons who are members of a single social network the causality analyzer 414 provides causality analysis that uses data acquired from a plurality of social media platforms and other sources. In some implementations, the causality analyzer 414 also determines the ratios of reward payout or other apportionment ratios of rewards to a plurality of persons to whom rewards are to be provided resulting from their performance or association with one or more rewardable activities.

Without limiting the foregoing, for example, in some implementations, the causality analyzer 414 is used within MADCARS 102 to determine whether a particular activity is sufficiently correlated (e.g., using mathematical correlations) with an objective (e.g., one set forth in the campaign manager 410) for which the MADCARS 102 has been engaged by a user (such as a music artist) to warrant the providing of a reward through the rewards manager 412 to one or more persons that engaged in the subject activity.

In some embodiments, the causality analyzer 414 is used within the MADCARS 102 to determine whether a particular activity is sufficiently correlated with another activity that is in turn ultimately sufficiently correlated with an objective (e.g., one set forth in the campaign manager 410) for which the MADCARS has been engaged by a user (such as a music artist) to warrant the providing of a reward through the rewards manager to one or more persons that engaged in the subject activity.

It is to be understood that the causality analyzer 414, in some implementations, be used to analyze causal relationships between a wide variety of activities and a desired objective for which the MADCARS 102 is used to obtain or assist in its obtaining. For example, activities such as listening to phone call, reading magazine, having a particular body function reading (blood pressure reading, eye dilation, galvanic skin reading, etc. associated with the consumption of content or participation in an event tracked by the MADCARS 102 could all function as activities for which the causality analyzer 414 could be used in some embodiments of the invention to draw inferences of causality between the activity and other activities and/or the accomplishment of a goal or other feature of a campaign.

The rewards manager 412 reward activities of a person or group, by monitoring and analyzing their public and private activities, comparing this information to various objectives set by persons, groups, or the system itself, and distributing rewards for the activities the system (through the action of the causality analyzer 414) deems most effective at achieving the objectives. For example, a user of the MADCARS sets the objective of promoting a given musical track, so whenever someone listens to that track, the system might reward the person who sent the track to the listener, and the person who sent the track to the person who sent it to the listener, and so on, such that everyone involved in getting that track in front of that listener shares in some portion of the reward. The chain of connections through which rewards are propagated may be explicit, like if one person Tweeted a track, and a series of other people retweeted, or the chain may be implicit, like if one person shared a track on Facebook, and one of their friends Tweeted the track after they saw the Share.

In some implementations, activities that may be rewarded, and information to feed the analysis the system makes, may come from sources including public blogs, websites, periodicals, broadcasts, as well as social media, friend maps, group affiliations, declared and implied affinities, geolocation data, other sources that the system has access to through permissions granted by users, as well as direct input of information by users or staff. In yet other implementations, the analysis, objectives, and internal models may be created, modified, and evolved by expert systems, genetic algorithms, neural networks, probabilistic reasoning, statistical analysis, symbolic logic, or other forms of natural and artificial intelligence. The activities that may earn rewards or be part of the chain that earns rewards may include tweets, shares, invitations to friends, creation of events, declared joining or attendance of events or groups, listening to, downloading, or streaming audio, video, or text, being geolocated in the vicinity of events or venues or persons or groups, donating money or points or anything else to another person or group, voting for a person, group, or initiative, liking something, adding something to favorites, posting a link to something, posting an image of someone or something, or commenting on something.

Another function of the reward manager 412 is to keep track using the reward data store 422 of what rewards were provided to persons, and how effective individual persons were regarding engaging in the rewardable activities (e.g. what persons engaged in the activities the most/least, etc.) In some implementations, the reward manager 412 also tracks and provides data regarding the relative levels of effectiveness of persons' rewardable activities directed to goals or objects of one or more campaigns coordinated by the campaign manager 410.

In the current implementations, the aforementioned tracking and evaluations of quantity and effectiveness of activity generation is performed on a dynamic basis. The rewards manager 412 provides a novel and nonobvious functionality directed to apportioning rewards in a more efficient manner than traditional referral means. Specifically, the rewards manager 412 apportions rewards based on discoveries and motivations of actions that comprise rewardable activities. In the current implementations the rewards manager 412 effectuates this throughout a network of providers of such activities, many of which are not users of the MADCARS or direct participants in a campaign. In fact, parties that may obtain rewards from the Rewards Manager may not be aware that their behaviors are generating Rewards until they realize they are entitled to them or are receiving them. This aspect of The System non-obviously exploits the fact that actions by persons (e.g., an Activity) that leads to a desired result (e.g. a desired Campaign result), perhaps indirectly or obliquely, can now, for the first time can be identified (e.g., by the joint operation of the Activity Scraper and Causality Analyzer) and can be rewarded (through the operation of the Rewards Manager) in an intelligent and dynamic fashion (under the control of the Campaign Manager, and indirectly, in some embodiments of the invention, via the Career Manager). In this way, The System, in general, and the Rewards Manager, in particular, provide a superior model for effective use of Rewards resources in comparison to a traditional recruiting or multilevel marketing regime which apportions rewards only to proximal participants in a closed program.

For example, the rewards manager 412 acquires data corresponding to the fact that a person, Eric, frequently listens to a particular track. The reward manager 412 suggests to Eric that he donate money to the artist who created that track. Eric agrees, so the system takes a portion of the donation and uses it to reward everyone responsible for Eric listening to that track.

If Suzy sent him the track, she receives a portion of the reward. If Suzy became interested in the track because John tweeted it and she read the tweet, then John would receive a portion of the reward. If John became interested in the track because he subscribes to a newsletter that Steve publishes, in which the track was mentioned by name, then Steve would receive a portion of the reward. If Steve became interested in the track after favoriting a YouTube® video in which the track is featured, and the YouTube® video was uploaded by Tali, then Tali would receive a portion of the reward. The received reward would be tracked by the reward manager 412 and recorded in the reward data store 422.

In another example, the MADCARS acquires data corresponding to the fact that Eric's geolocation (determined via the geolocation of a computer device physically associated with Eric) puts him in the venue of a show that Steve is promoting. The system notices that Suzy, who is in a relationship with Eric on Facebook, is also at that location, and that she purchased two tickets to the event. It rewards Suzy for bringing Eric. Because the system notices that Jennifer send a ticket purchase link to Suzy via email or instant message, it rewards Jennifer. Because the system notices that the live stream of KCRW announced the show, and Jennifer was listening to that live stream right before she sent the ticket link to Suzy, it rewards KCRW.

In other implementations, the MADCARS acquires data corresponding to the fact that Eric, Suzy, and Jennifer all add a specific track to their playlists about the same time, and their geolocation data puts them all in the same place, along with Andrew. None of them have listened to that track previously, but Andrew has, and has favorited it. The MADCARS infers via the causality analyzer 414 that Andrew just played the track for them and so it rewards him for introducing them all to that track.

In some implementations, the “person” to whom rewards are provided by or through the functioning of the MADCARS 102, may be a non-human person, such as a business, a non-human legal entity, a computer, a robot, a cyborg, a cybernetic being, a digitally enhanced human or a bio-enhanced digital device. It is also foreseeable that in certain embodiments, rewards can be filtered by target audience and the providing of rewards may move through chain of causality of activities that satisfy the criteria for such rewards. In this regard rewards in the instant invention not limited to rewards that are awarded through a traditional chain of recruiting, as is seen in traditional multilevel marketing regimes.

The different features, procedures, and/or modules (career manager 406, campaign manager 410, reward manager 412, causality analyzer 414, and activity scraper 404 may be accessed via the user interface 324 that may be accessed by a client 108. The user interface may also directly communicate with the third party vendors 402. Examples of third party vendors 402 may include ticket sales websites, venues for tickets, virtual stores, brick and mortar stores, polling sites, to give but a few examples.

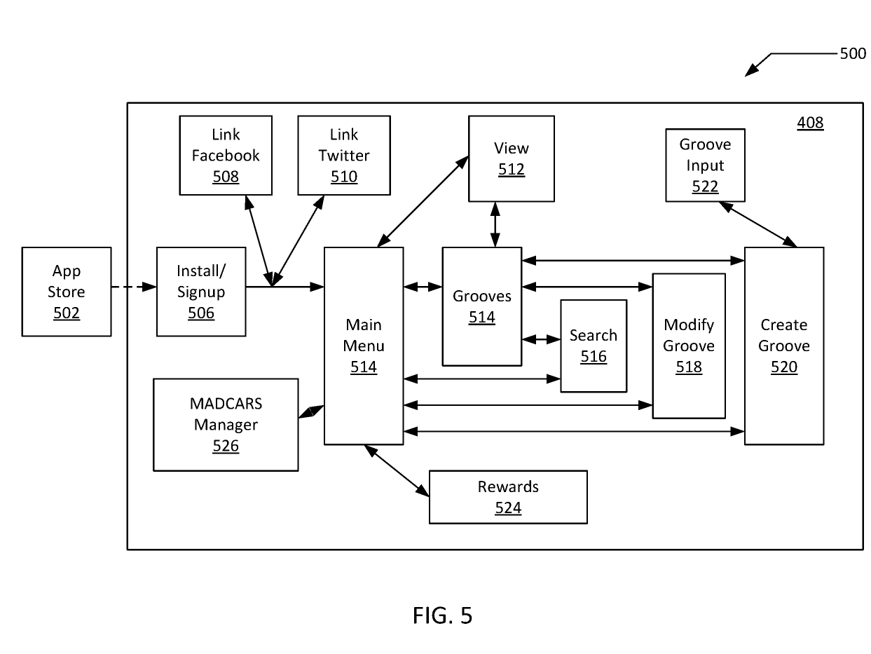

In FIG. 5, a diagram 500 of a user interface for the MADCARS 102 of FIG. 1-3 is illustrated in accordance with an example implementation. The user interface is part of a user application (UA) that is executed on the client 108. The UA may be downloaded from an app store 502, such as GOOGLE PLAY or APP STORE, or accessed online. After being downloaded, the user interface user app is installed and the user is prompted for signup with the MADCARS 102 by the Install/Signup block 506. Once installed on the client 108, the user interface (user interface App) 408 presents a main menu 514. From the main menu the user may link to FACEBOOK 508, TWITTER 510 (if not done during install), view 512 grooves, search 516 grooves 514, modify grooves 518, create grooves 520, check rewards 524, and access the MADCARS advanced features (reward manager 412, career manager 406, campaign manager 410, causality analyzer 414, and activity scraper 404) via the MADCARS manager 526. Grooves 514 may be streaming content, such as a streaming digital show, streaming music, streaming music station, or other digital media. In some implementations, audio and/or video may be directly transferred/streamed into the system via the groove input 522. For example by using a “live broadcast out” feature built into the DJ software, such as TRAKTOR, by NATIVE INSTRUMENT, a live stream of a groove can occur. Thus, using a DJ software's “Live broadcast out” function to create a groove can result in rewards (monetary or otherwise) for views of the groove. In other implementations, this approach for rewarding creation of a groove by viewers of that groove can also be built into other visual and/or audio creation software.

In the current implementation, installed UA captures the phone ID/device ID/IP address, etc. and stores that in one or more data stores of the MADCARS 102 along with a user identification and password. As part of the install process, the UAU interacts with data seeking pages and authorizations to provide such data. For example, the UAU may be asked via a prompt displayed in the User App Interface:

“Link Facebook? Y/N

Link Twitter? Y/N

Link Stage 32 Y/N”, etc.

During the install process, the UAU is prompted with the displayed questions regarding setting up a personal station, such as: “Generate personal station?” and “Make station private (public by default)?”

In some embodiments, the UA Interface provides to the UAU a page whereby “grooves” 514 are displayed. In another implementation, the grooves are stations that stream music or other content, such as stations are Internet radio stations. In other implementations, scrolling list of grooves includes labeled links to individual streams or content which may include without limitation. Examples of include one or more links to one or more of the following: live audio content, recorded audio content, live video content, recorded video content, live virtual reality content, recorded virtual reality content, still images, text, games, apps (e.g., productivity apps, groove creation helper apps, etc.), e-commerce.

The UA may allow for one or more works that are “now playing.” In at least one embodiments, the works that are playing are playing through one or more “stations” that have been associated by the MADCARS with the UAU's UA (e.g. as default stations). One or more of such stations and/or others that may be selected by the UAU and comprise stations that are sublicensed to the UAU to be the “DJ” for one or more of a number of stations contemplated to be a part of the Free Music On Demand features of MADCARS as described below.

In some preferred embodiments of the invention the grooves 514 displayed (view 512) in a UAU's UA are selected based on analyzed prior activity by the UAU. A search function 516 may be provided 516 that enables UAU access to one or more types of search functions is provided on the one or more pages of the User App Interface 408. In some embodiments, the search function provides to the UAU the ability to perform searches by artist, genre, track, venue, location, type, mood, similarities to other grooves, etc.

In some embodiments, the search function 516 identified herein as the OSE associated with the Free Music On Demand portion of MADCARS 102 is a feature available via the search function. As indicated below, this search feature enables a UAU to determine whether, a work is then currently playing via an Internet radio station streaming the work, find such stream(s), and stream the work to the UAU's computer device.

Live video streams Grooves can be created with a green screen background, (typical used in the film industry for special effect as green screen background makes it easier to digitally change the background) the broadcaster who is streaming Live may then chose different backgrounds from an archive of famous backgrounds provided by the MADCARS 102. Some of these custom background, or “skins”, can range from other nightclubs around the world and festivals and also, famous land marks and famous nature areas. By earning status by collecting rewards or paying real money, a user may choose from premium skin backgrounds that are not available to a regular user or for free. By choosing one of these custom digital skins, a broadcaster creating a Groove can then enhance their own broadcast by making their live stream more visually appealing compared to let's say, just doing a live stream from a bedroom. As a result of this action, the user can be exposed to earning more rewards in donations due to how effective and attractive this background skin is.

In some preferred embodiments of the invention, “default groove” is added to list of grooves when the UAU first accesses the UA Interface 408. Data regarding the UAU's activities choosing preferences regarding the UA Interface 408, as well as interactions in, at and through the UA is provided to the career manager 406, campaign manager 410, activity scraper 404 and/or reward manager 412.

The UAU can also be provided with means through the use of the UA to create one or more custom “groove” stations. The UA interface 408 when creating the groove 520 prompts the UAU to select whether he or she wants the station to be a station that will be broadcasting immediately or should be scheduled for broadcast at a later time. In preferred embodiments of the invention, such broadcasts are available to all other UAUs using MADCARS 102. In other implementations, the UAU is provided with tools useable through MADCARS 102 that, for example can assist the UAU to include a telepresence in live or recorded virtual reality content when creating grooves 514 (grooves may be physically stored in a data store 114, i.e. a groove data store) with the create groove function 520. In some implementations, it is foreseeable that advertising will also appears on one or more pages of the User App Interface 408.

Selection of a groove by a UAU will results in the display of a “View” page 512. In preferred embodiments of the invention, the view pages includes functionality that enables the UAU to engage in transactions involving an artist or other entity. For example, the UAU is provided with a prompt and functionality that enables the purchase of tickets to an artist's show where the locations of one or more such shows are provided in association with the location of the UAU's computer device associated with the UAU.

The view pages accessed via the view function 512 includes a displayed option and related functionality to enable the UAU to share a musical work, playlist, station, or other content with another UAU or with outside parties, such as via social media. In some implementations, the view pages may also include a displayed option and related functionality to enable the UAU comment, blog or otherwise disseminate commentary regarding a groove, a station and/or other content available via the UA interface 408. The view pages may also include a displayed option and related functionality to donate and/or invest in the related artist, a project of the artist, his or her company, etc. A donation manager is used by the MADCARS 102 to assist in donations and investments where intervening actions are required to be presented to the UAU to effectuate compliance with governmental regulations, etc. The donation manager may be implemented as a special type of activity. The actions taken by the UAU, which comprise rewardable activities are tracked by the system and made available to parts thereof (such as to the career manager 406, the campaign manager 410, the activity scraper 404, and the rewards manager 412). Money, points and other things of value received through the UA is apportioned in accordance with rules set in the campaign manager 410 and provided through MADCARS 102 to fund the pool of rewards that are apportioned to persons via the rewards manager 412.

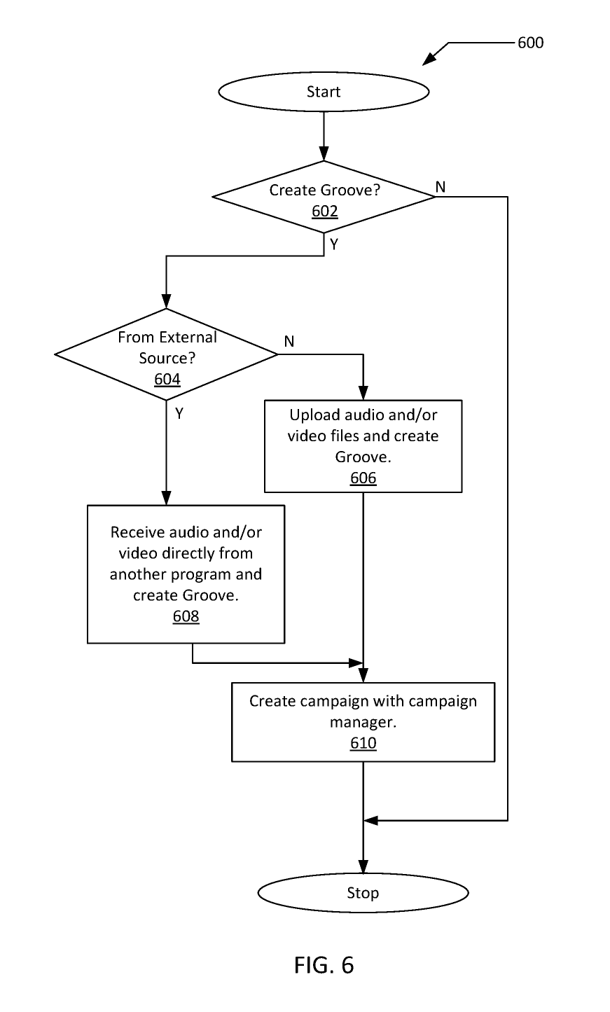

FIG. 6 is an illustration 600 of a flow diagram of an approach for MADCARS 102 executed by the server 104 in accordance with an example implementation of the invention. A user using the user interface 408 running on a client 108 access the MADCARS 102 via the main menu 514. The user interface may be implemented as a web application executing a computer language, such as a mark-up language HTML. Via the main menu 514, the user may select to create a grove 520 in step 602. The user is able to choose if the groove (an audio and/or video encoded file or stream) is a stream from an external source via the groove input 522 in step 604. If the groove is not from an external source then the user interface for creating a groove 520 enables selection of an audio and/or video file for the groove in step 606. Creation of the groove results in a groove file that is formatted as a groove and selectable for playing and searching.

If the groove is from an external source or program, such as a DJ program, it is may be received via the groove input 522 as streaming data in the current example in step 604. The received streaming data is then process and a groove created. Once the groove is crated, a campaign may be created with the campaign manager 410 using data from the activity data store 420, campaign data store 418. The campaign created in step 610 will include rewards managed by the reward manager 412. If a groove is not to be create in step 602, then processing of creating a groove 520 is complete.

It will be understood, and is appreciated by persons skilled in the art, that one or more processes, sub-processes, or process steps described in connection with FIG. 4-6 may be performed by hardware and/or software (machine readable instructions). If the approach is performed by software, the software may reside in software memory in a suitable electronic processing component or system such as one or more of the functional components or modules schematically depicted in the figures.

The software in software memory may include an ordered listing of executable instructions for implementing logical functions (that is, “logic” that may be implemented either in digital form such as digital circuitry or source code or in analog form such as analog circuitry or an analog source such an analog electrical, sound or video signal), and may selectively be embodied in any computer-readable medium for use by or in connection with an instruction execution system, apparatus, or device, such as a computer-based system, processor-containing system, or other system that may selectively fetch the instructions from the instruction execution system, apparatus, or device and execute the instructions. In the context of this disclosure, a “computer-readable medium” is any tangible means that may contain or store the program for use by or in connection with the instruction execution system, apparatus, or device. The tangible computer readable medium may selectively be, for example, but is not limited to, an electronic, magnetic, optical, electromagnetic, or semiconductor system, apparatus or device. More specific examples, but nonetheless a non-exhaustive list, of tangible computer-readable media would include the following: a portable computer diskette (magnetic), a RAM (electronic), a read-only memory “ROM” (electronic), an erasable programmable read-only memory (EPROM or Flash memory) (electronic) and a portable compact disc read-only memory “CDROM” (optical). Note that the tangible computer-readable medium may even be paper (punch cards or punch tape) or another suitable medium upon which the instructions may be electronically captured, then compiled, interpreted or otherwise processed in a suitable manner if necessary, and stored in a computer memory.

The foregoing detailed description of one or more embodiments of the approach for a dynamic multilevel rewards systems using multiple data source inputs of activity information has been provided. It will be recognized that there are advantages to certain individual features and functions described herein that may be obtained without incorporating other features and functions described herein. Moreover, it will be recognized that various alternatives, modifications, variations, or improvements of the above-disclosed embodiments and other features and functions, or alternatives thereof, may be desirably combined into many other different embodiments, systems or applications. Presently unforeseen or unanticipated alternatives, modifications, variations, or improvements therein may be subsequently made by those skilled in the art which are also intended to be encompassed by the appended claims. Therefore, the spirit and scope of any appended claims should not be limited to the description of the embodiments contained herein.

What is claimed is:

1. A multisource acquired and data causation analyzed reward system (MADCARS) for creating a groove streaming media file, comprising:
a processor;
a groove data store having a plurality of grooves; and
a campaign manager executed by the process that associates a groove streaming media file with a campaign, where the campaign includes rewards that are issued in response to an activity identified by the campaign and received from an activity scraper controlled by the processor.

2. The MADCARS of claim 1, where the activity is an action that is associated with digitally characterizable data.

3. The MADCARS of claim 2, where the activity is received at the groove system from a social media website via the network interface, where the network interface is responsive to the processor.

4. The MADCARS of claim 1, where the groove data is an audio encoded data file.

5. The MADCARS of claim 1, where the groove data is an audio and video encoded data file.

6. The MADCARS of claim 1, where the plurality of grooves includes at least one groove directly streamed to the MADCARS via a groove input.

7. The MADCARS of claim 1, where the rewards are managed by a rewards manager that is controlled by the processor and issues rewords in response to the activity and the campaign.

8. A method for a multisource acquired and data causation analyzed reward system (MADCARS) having groove streaming media files, comprising:
selecting a groove streaming media from a plurality of groove streaming media files with a user interface controlled by a processor;
generating a campaign for the groove with a campaign manager executed by the process that associates a groove streaming media file with a campaign, where the campaign includes rewards;
receiving from an activity scraper controlled by the processor and activity; and
issuing rewards in response to the activity that is identified in the campaign.

9. The method for a MADCARS of claim 8, where the activity is an action that is associated with digitally characterizable data.

10. The method for a MADCARS of claim 9, where receiving the activity further includes receiving the activity from a social media website via the network interface, where the network interface is responsive to the processor.

11. The method for a MADCARS of claim 8, includes encoding the groove data as an audio data file.

12. The method for a MADCARS of claim 8, includes encoding the groove data as an audio and video encoded data file.

13. The method for a MADCARS of claim 8, receiving a groove directly via a groove input.

14. The method for a MADCARS of claim 8, includes managing the rewards with a rewards manager that is controlled by the processor and issues rewords in response to the activity and the campaign.

15. A computer readable medium having a plurality of non-transient machine readable instructions for a multisource acquired and data causation analyzed reward system (MADCARS) having groove streaming media files, when executed comprises the steps of:
selecting a groove streaming media from a plurality of groove streaming media files with a user interface controlled by a processor;
generating a campaign for the groove with a campaign manager executed by the process that associates a groove streaming media file with a campaign, where the campaign includes rewards;
receiving from an activity scraper controlled by the processor and activity; and
issuing rewards in response to the activity that is identified in the campaign.

16. The computer readable medium of claim 15 having a plurality of non-transient machine readable instructions, where the activity is an action that is associated with digitally characterizable data.

17. The computer readable medium having a plurality of non-transient machine readable instructions of claim 16, where receiving the activity further includes instructions for receiving the activity from a social media website via the network interface, where the network interface is responsive to the processor.

18. The computer readable medium having a plurality of non-transient machine readable instructions of claim 15, includes instructions for encoding the groove data as an audio data file.

19. The computer readable medium having a plurality of non-transient machine readable instructions of claim 15, includes instructions for encoding the groove data as an audio and video encoded data file.

20. The computer readable medium having a plurality of non-transient machine readable instructions of claim 15, includes receiving a groove directly via a groove input.

21. The computer readable medium having a plurality of non-transient machine readable instructions of claim 15, includes instructions for managing the rewards with a rewards manager that is controlled by the processor and issues rewords in response to the activity and the campaign.
